(19) United States
(12) Patent Application Publication
(10) Pub. No.: US 2006/0250895 A1
(43) Pub. Date: Nov. 9, 2006

(54) Talking calendar and event scheduler

(76) Inventor: Osvaldo Sanchez, Bedford, TX (US)

Correspondence Address: John E. Vandigriff, 906 Stone Circle Ln, Lewisville, TX, 75056, US

(21) Appl. No.: 11/124,554

(22) Filed: May 9, 2005

(51) Int. Cl. G04B 19/24

(52) U.S. Cl. 368/29

(57) ABSTRACT

A clock calendar device displaying events, time and date. A display shows holiday events, special occasions, and shows the date in an enlarged format. The clock calendar device is adaptable for the use by children to teach them to read time, date and month. By pressing the appropriate button, the clock calendar devices will announce the time, date, month, and any other recorded statement. Recorded statements may be associated with any date on the calendar by indicating the appropriate date and recording the desired statement.

### FIELD OF THE INVENTION

The invention relates to electronic calendars, and more particularly to a calendar adaptable for children use for recording and displaying events, and announcing days, months, years and time.

### BACKGROUND OF THE INVENTION

Various time pieces and clock are available to show time and date in various formats, and to show holiday events. Several patents are described below to show the existing state of the art.

U.S. Pat. No. 4,162,610 describes an electronic schedule calendar and diary for storing in an electronic memory a plurality of future calendar appointments and events for each of a plurality of daily, weekly, or other date interval periods, and enabling the selective retrieval and electronic display of said plural appointments and events for any selected time period. The electronic diary employs manually or remotely controlled entry of said future appointments and events in digital form; manually or remotely controlled correction and updating of said data; and manually controlled retrieval or readout into a visual electronic display. A time-of-day electronic clock may also be included together with an automatic alarm for providing an alarm for each selected appointment or event entered into the memory. In a systems version, a plurality of electronic diaries are employed with a central memory or monitor. Each diary is selectively placed in communication with the central memory for transfer of data therebetween.

U.S. Pat. No. 4,176,478, is a calendar having detachable components for perpetually arranging the calendar. The removable components are secured by a strip of magnetic tape secured to the rear portion which is attracted to ferris metal tacks secured on a board to hold the calendar components. The extra components are stored in a storage compartment behind the board.

U.S. Pat. No. 6,186,553 defines a customizable theme calendar includes a set of date cells corresponding to an arbitrarily designated time period (e.g., a starting date and a target date), and a theme applied to the calendar. The theme corresponds to an event associated with the arbitrarily designated time period. The time periods and themes may correspond to recognized holidays such Halloween, Thanksgiving, Easter and so on, or to arbitrarily designated events having personal or familial significance, such as weddings, birthdays, anniversaries, etc. Such customized calendars may be designed and generated in connection with a computer system and calendar generation software.

### SUMMARY OF THE INVENTION

The invention is a clock calendar device for displaying events, time and date. A display shows holiday events, special occasions, and shows the date in an enlarged format. The clock calendar device is adaptable for the use by children to teach them to read time, date and month. By pressing the appropriate button, the clock calendar devices will announce the time, date, month, and any other recorded statement. Recorded statements may be associate with any date on the calendar by indicating the appropriate date and recording the desired statement.

The clock calendar device may be programed for various languages and present different themes by the use of interchangeable memory storage devices.

The technical advance represented by the invention as well as the objects thereof will become apparent from the following description of a preferred embodiment of the invention when considered in conjunction with the accompanying drawings, and the novel features set forth in the appended claims.

### BRIEF DESCRIPTION OF THE DRAWINGS

FIG. 1 is a front view of the clock calendar device;

FIG. 2 is a back view of the clock calendar device;

FIG. 3 is a side view of the clock calendar device; and

FIG. 4 is an example of a block diagram for a circuit for the clock calendar device;

### DESCRIPTION OF A PREFERRED EMBODIMENT

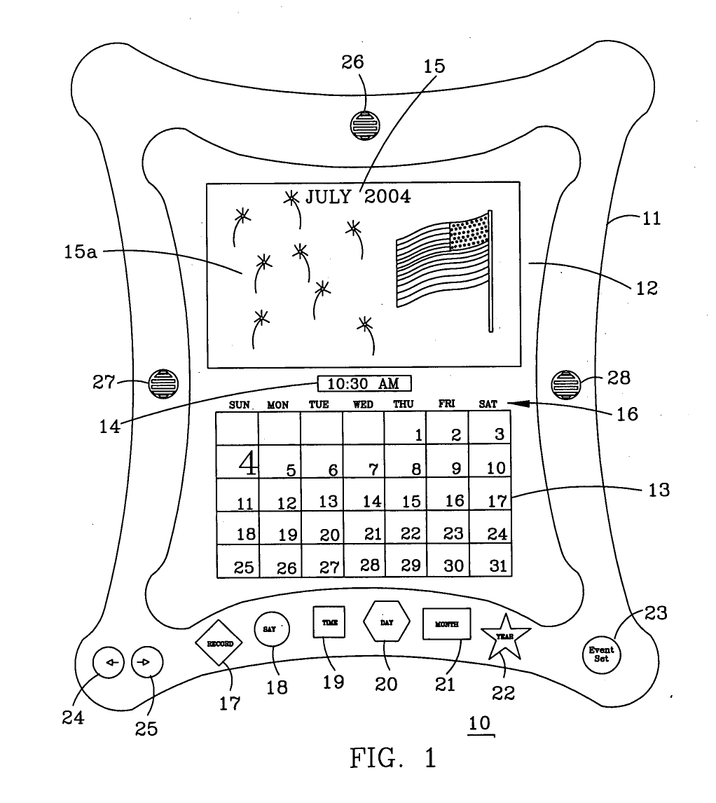

FIG. 1 is a front view of the clock calendar device 10 having a body or housing 11 which includes a display screen 12. Display 12 screen may be a single display screen or may be several individual smaller display screens. Displayed 12 includes a display of the month and year 15 and programable or changeable theme display 15a. Also displayed is the time 14 and a calendar 13. Calendar 13 shows a standard calendar with the days of the month and each day. The present day is enlarged. For example as indicated, the month is July in the year 2004. The day is the 4^{th}. The “4” is enlarged so that one looking at the calendar will know that the day is the 4^{th} since it is enlarged. The clock and calendar are programed to display the proper time and date as explained below.

Clock calendar device 10 includes several buttons to accomplish or present different functions when pressed. Button 17, marked RECORD is used for recording comments that are to be associated with a particular date. For example, a voice comment may be associated with a particular date to announce a event such as ball practice of a birthday. When button 17 is pressed, speaking in to microphone 26 records the voice message, which is stored in a memory, described below, in the clock calendar device.

Button 18, labeled “SAY” is used to retrieve the recorded message, recorded with button 17. If there is a message associated with a particular date, when button 18 is pressed on that date, then the recorded message will be played over speakers 27 and 28.

Button 19 is used to announce the time. When button 19 is pressed, the time will be announced over the speakers 27 and 28.

Button 20 is used to announce the day of the month and button 21 is used to announce the month. Each of the day and month are announced through speakers 27,28 when the respective button is pressed. Similarly, the year is announced when button 22 is pressed.

The Event Set button 23 is used to set the time and date that an event is to be recorded. By pressing the Event Set button 23 once, the it a date programming mode is initiated. Press it a second time and a month programming mode is initiated. Press it a third time and the programing mode is stopped.

For example, press the Event Set button 23 once and the date of the presently indicated month is moveable back or forward by buttons 24 and 25 to set the day of the month the event is to be recorded. While in the “set date” mode, the record button 17 may be pressed, held in and a voice message maybe recorded to be announced on that date. After the announcement is recorded, then the Event Set button 23 is pressed again to the month mode. If the month is not to be changed, then the Event Set button 23 is pressed again to stop the programming mode. When the clock calendar leaves the programming mode, the clock calendar returns to the present date.

Display screen 12 may be changed to display different themes, for example, in FIG. 1 the date and month is illustrated as July 4^{th}. A July 4^{th} theme is displayed showing the American flag and a “fireworks” display. By utilizing a memory unit, described below, the theme may be changed to display various holidays. An additional feature that may be associated with the memory unit is that the language display of the clock calendar device may be changed, for example, from English to Spanish.

There may be a remote unit associated with the clock calendar device. The remote having the same function buttons as the clock calendar and communicating with the clock Calendar via infra red or radio frequency.

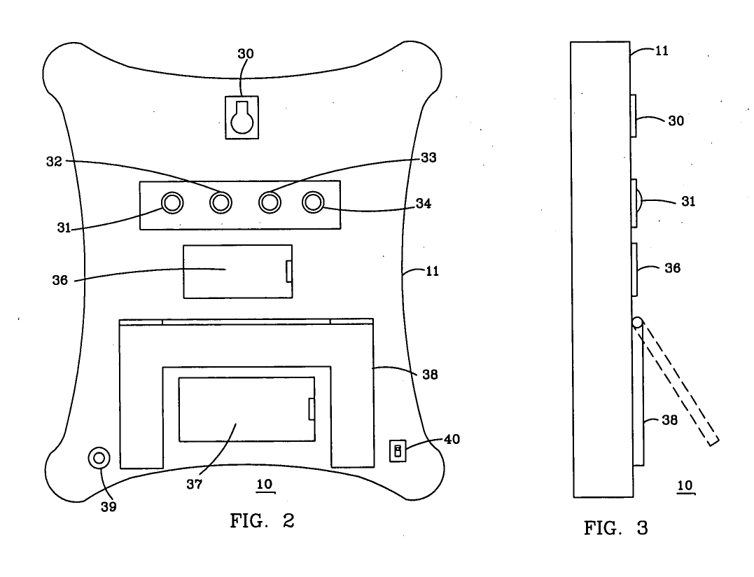

FIG. 2 is a back view of the clock calendar device 10. At the top of housing 11 is a mounting device 30 for mounting the clock calendar device on a wall. Below mounting device 30 are four buttons 31, 32, 33 and 34. These button are for setting the time and date, and alarm on the clock calendar device 10. The Time is set by pushing button 31 one time and then using button 32 for setting the hour and button 33 for setting the minute. When button 31 is pressed a second time, then button 32 is used of setting the month and button 33 is used for setting the year. Pressing button 31 a third time stores the time and date as entered.

Button 34 is used in conjunction with buttons 32 and 33 for setting an alarm. When button 343 is pressed once, buttons 32 and 33 are used for setting the time in hour and minute for the alarm. When button 34 is pressed again, then the alarm is set to the desired day and month. Pressing button again, for the third time stores the alarm day and month.

Compartment 36 is for batteries to run the clock calendar when not connected to a power source, and to retain programing when the power is off or the clock calendar is moved from one place to another.

Compartment 37 is used for inserting a memory device for programing the clock calendar and storing information such as the stored voice messages, theme displays shown on screen 12, and for storing different language displays.

Power to clock calendar device is supplied via connector 39 and a power supply, not illustrated.

Switch 40 may be used to switch between languages, for example English and Spanish, the programming of which is on a memory device in compartment 37.

The clock calendar 10 may be mounted on a flat surface using stand 38.

FIG. 3 is a side view of clock calendar 10 showing housing 11, set button 31, battery compartment 36 and stand 38. Stand 38 may be extended to place the clock calendar on a flat surface, of it may be mounted on a wall using mounting device 30.

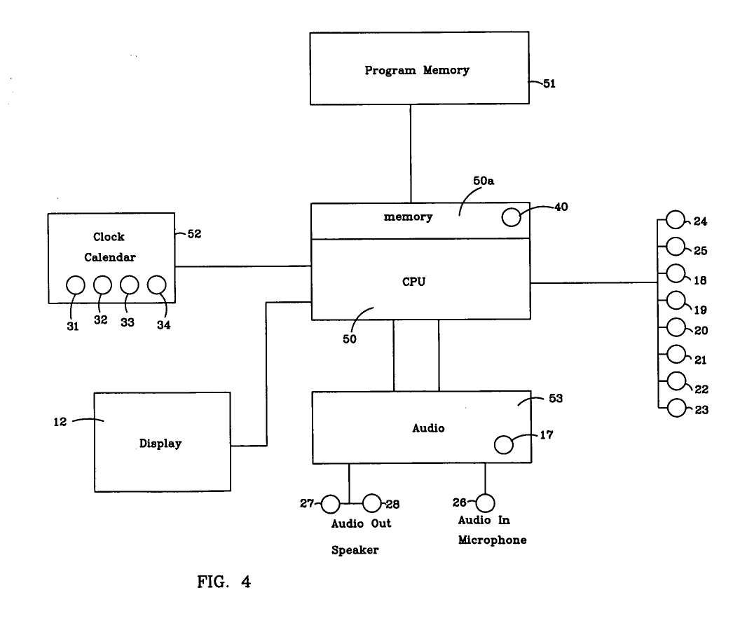

FIG. 4 is an example of a block diagram for a circuit for the clock calendar device. A CU 50 includes a memory 50a which includes the overall programming for the clock calendar. A second interchangeable memory 51 may be attached to the clock calendar for programing various languages and present different themes. Switch 40 may be used to switch between languages, for example English and Spanish.

The clock circuit 52 has the standard control buttons 31-34. These button are for setting the time and date, and alarm on the clock calendar device 10. The Time is set by pushing button 31 one time and then using button 32 for setting the hour and button 33 for setting the minute. When button 31 is pressed a second time, then button 32 is used of setting the month and button 33 is used for setting the year. Pressing button 31 a third time stores the time and date as entered.

The display 12 is shown and describe with referenced to FIG. 1.

The audio unit 53 includes the record button 17, which allows the recording of messages and announcements. Audio in is a microphone 26 and the audio out is a set of speakers 27 and 28.

The other control buttons 18, 19, 20, 21, 22, 23 and 24 control the various functions of the clock calendar as described with referenced to FIG. 1.

What is claimed:

1. A clock calendar device for displaying events, time and date, comprising:
a programable clock and calendar device with a plurality of program and event activation buttons;
a display screen for displaying holiday events, special occasions, and the date;
an audio device for recording and announcing statements which, when pressing an event activation button, will announce the time, date, month, and any other recorded statement.

2. The clock calendar device according to claim 1, the announcement statements may be associate with any date on the calendar by indicating the appropriate date and recording the desired statement.

3. The clock calendar device according to claim 1, including an interchangeable memory device for programing the clock calendar and storing information such as stored voice messages, theme displays shown on the display screen, and for storing different language displays.

4. The clock calendar device according to claim 1, wherein the present date is shown in an enlarged format.

5. The clock calendar device according to claim 1, where in the display screen has at least two regions of display, one of displaying a calendar and time, and another for display a theme event.

6. The clock calendar device according to claim 5, wherein the theme event is programable and changeable.

7. The clock calendar device according to claim 1, wherein the clock calendar device has at least one microphone and one speaker.

8. The clock calendar device according to claim 1, including a remote unit for communicating and programming the clock calendar.

9. A clock calendar device for displaying events, time and date, comprising:
a programable clock and calendar device with a plurality of program and event activation buttons;
a display screen for displaying holiday events, special occasions, a calendar, and the date;
an audio device for recording and announcing statements which, when pressing an event activation button, will announce the time, date, month, and any other recorded statement.

10. The clock calendar device according to claim 9, the announcement statements may be associate with any date on the calendar by indicating the appropriate date and recording the desired statement.

11. The clock calendar device according to claim 9, including an interchangeable memory device for programing the clock calendar and storing information such as stored voice messages, theme displays shown on the display screen, and for storing different language displays.

12. The clock calendar device according to 9, wherein the present date is shown in an enlarged format.

13. The clock calendar device according to claim 9, where in the display screen has at least two regions of display, one of displaying a calendar and time, and another for display a theme event.

14. The clock calendar device according to claim 13, wherein the theme event is programmable and changeable.

15. The clock calendar device according to claim 9, wherein the clock calendar device has at least one microphone and one speaker.

16. A clock calendar device for displaying events, time and date, comprising:
a programmable clock and calendar device with a plurality of program and event activation buttons;
a display screen having at least two display areas for displaying holiday events, special occasions, a calendar, and the date;
an audio device for recording and announcing statements which, when pressing an event activation button, will announce the time, date, month, and any other recorded statement.
